(19) United States
(12) Patent Application Publication
(10) Pub. No.: US 2024/0127275 A1
(43) Pub. Date: Apr. 18, 2024

(54) METHOD, SYSTEM, AND STORAGE MEDIUM FOR MATCHING A SELLER AND A BUYER

(71) Applicant: R&D CO-OP, INC., LOS ANGELES, CA (US)

(72) Inventor: Kenna Zemedkun, Los Angeles, CA (US)

(21) Appl. No.: 18/486,901

(22) Filed: Oct. 13, 2023

Related U.S. Application Data
(60) Provisional application No. 63/415,849, filed on Oct. 13, 2022.

(51) Int. Cl. G06Q 30/0203

(52) U.S. Cl. CPC G06Q 30/0203

(57) ABSTRACT

Embodiments of the present disclosure may include a system for creating a matching score between a seller and a buyer, a method for creating a matching score between a seller and a buyer, and a non-transient computer-readable storage medium comprising instructions to perform a method for creating a matching score between a seller and a buyer. The method may include steps of providing the system for creating the matching score, receiving a seller zero party dataset and a buyer zero party dataset, obtaining at least one third party dataset, calculating a social matching score, a textual matching score, and a presets matching score, merging the social matching score, the textual matching score, and the presets matching score with a merging algorithm to provide the matching score between the seller and the buyer, whereby the matching score is an indicator of a degree of alignment of the buyer and the seller.

### CROSS-REFERENCE TO RELATED APPLICATIONS

This application claims the benefit of U.S. Provisional Application Ser. No. 63/415,849, filed on Oct. 13, 2022. The entire disclosure of the above application is incorporated herein by reference.

### FIELD

The present disclosure relates generally to a method, system, and storage medium for matching a seller and a buyer, and more particularly, to a method, system, and storage medium for matching a seller and a buyer using a matching score.

### INTRODUCTION

This section provides background information related to the present disclosure which is not necessarily prior art.

A profitable partnership between a seller and a buyer requires both the seller and the buyer to have a thorough understanding of how the partnership may be mutually beneficial and the qualities and needs of one another. The success of any partnership is often a result of the information available during the matching process. However, datasets used in the matching process are often suboptimal and do not accurately represent the attitudes and goals of the buyer and/or the seller. As such, buyers and sellers in any number of industries face challenges in establishing a comprehensive and accurate evaluation system to determine the viability of partnerships. The existing methods often fall short in providing a holistic perspective on both sellers and buyers, resulting in missed opportunities for meaningful collaborations, unsuccessful partnerships, and wasted time and resources.

It can be especially difficult to establish datasets, algorithms, and scores comparing the seller and buyer that paint a complete picture of both parties and that can accurately predict the outcome of these partnerships for both the seller and the buyer. Additionally, sellers and buyers often must rely on third parties such as brokers and talent representatives to communicate needs and wishes, which can lead to information being left out and subjective and/or inaccurate outside data being too heavily relied upon. As a result, partnerships may be overlooked or unsuccessful.

Various methods for matching a buyer and a seller in order to form a partnership are known. For example, U.S. Patent Application Publication No. 2022/0343268 describes a method of sourcing materials by connecting a seller having inventory with a buyer needing inventory. U.S. Patent Application Publication No. 2013/0166340 describes software for matching a buyer in need of a skilled worker and a seller having a particular required skill. In another example, U.S. Patent Application Publication No. 2023/0237601 describes a method of matching a buyer and a seller with respect to real estate transactions.

However, these patents fail to teach methods that incorporate datasets provided by both the seller and buyer including interests, preferences, needs, likes and dislikes, as well as third party datasets that may assist in determining how successful a potential partnership may be. Additionally, these patents fail to teach including modules that are capable of evaluating and comparing seller and buyer datasets using preset algorithms and that are capable of continually evolving using artificial intelligence and the like. Existing algorithms do not utilize traditional demographic data and do not incorporate additional layers of information such as editorial preferences, psychographic attributes, and linguistic syntax.

Examples of datasets that may be useful in forming optimal partnerships may include zero party datasets, third party datasets, and additional datasets processed using artificial intelligence and predetermined algorithms. Additionally, information provided directly from the seller and the buyer through various information-collecting means such as questionnaires and surveys, as examples, may also improve the information that is relied upon throughout a matching process, thereby ensuring a more successful partnership.

Accordingly, there is a continuing need for an accurate, complete, customizable, and data driven method of matching a seller and a buyer using a matching score that is formulated to include a variety of relevant and curated datasets. Desirably, the matching score will reflect an accurate comparison of those datasets with respect to the seller and the buyer.

### SUMMARY

In concordance with the instant disclosure, an accurate, complete, customizable, and data driven method of matching a seller and a buyer using a matching score that is formulated to include a variety of relevant and curated datasets, as well as an accurate comparison of those datasets with respect to the seller and the buyer, has surprisingly been discovered.

In one embodiment, a method for creating a matching score between a seller and a buyer may comprise includes a step of providing a matching system. The matching system includes a seller device, a buyer device, and at least one system server.

The seller device may include a seller device human interface, a seller device memory, a seller device processor, and a seller device display. The seller device human interface may be configured for inputting a seller zero party dataset, the seller zero party dataset including at least one answer by the seller to at least one seller questionnaire. The seller device memory may have machine-readable instructions stored on the seller device memory, and the seller device processor may be in communication with the seller device human interface and the seller device memory.

The buyer device may have a buyer device human interface, a buyer device memory, a buyer device processor, and a buyer device display. The buyer device human interface may be configured for inputting a buyer zero party dataset. The buyer zero party dataset may include at least one answer by the buyer to at least one buyer questionnaire. The buyer device memory may have machine-readable instructions stored on the buyer device memory, and the buyer device processor may be in communication with the buyer device human interface and the buyer device memory.

The at least one system server may have a system server memory and a system server processor. The at least one system server may be accessible by an administrator. The at least one system server may be in communication with the seller device, the buyer device, and at least one third party server through a wide area network. The at least one third party server may have at least one third party dataset. The system server memory may store a buyer needs dataset for the buyer and a plurality of modules including tangible, non-transitory processor executable instructions. The plurality of modules may include a social matching score module, a textual matching score module, a presets matching score module, a merging module, and an artificial intelligence module.

The method may further include steps of receiving, by the at least one system server from the seller device, the seller zero party dataset, receiving, by the at least one system server from the buyer device, the buyer zero party dataset, and obtaining, by the at least one system server from the at least one third party server, the at least one third party dataset.

The method may include the step of calculating, by the social matching score module of the at least one system server, a social matching score from the at least one third party dataset and the buyer needs dataset, the social matching score associated with both the seller and the buyer. The method may also include the step of determining, by the textual matching score module of the at least one system server, a textual matching score from the seller zero party dataset and the buyer zero party dataset. The method may further include the step of processing, by the presets matching score module of the at least one system server, the at least one answer by the seller to the at least one seller questionnaire and the at least one answer by the buyer to the at least one buyer questionnaire with the artificial intelligence module to provide a presets matching score.

Additional steps may include merging, by the merging module of the at least one system server, the social matching score, the textual matching score, and the presets matching score with a merging algorithm to provide the matching score between the seller and the buyer, whereby the matching score is an indicator of a degree of alignment of the buyer and the seller, and transmitting the matching score from the at least one system server to at least one of the seller device and the buyer device.

In another embodiment, the system for implementing the aforementioned method is provided.

In a further embodiment, a non-transient computer-readable storage medium comprising instructions being executable by one or more processors to perform the aforementioned method is provided.

In an exemplary embodiment, the method, system, and associated computer readable storage medium may be configured for creating a personalized score. In some cases, the system may include one or more computing platforms. The one or more remote computing platforms may be communicably coupled with one or more remote platforms. In some cases, users may access the system via remote platform(s).

The one or more computing platforms may be configured by machine-readable instructions. Machine-readable instructions may include modules. The modules may be implemented as one or more of functional logic, hardware logic, electronic circuitry, software modules, and the like. The modules may include one or more of a device module, a user permitting module, a criteria transmitting module, a score creating module, a score transmitting module, a display generating module, an information providing module, and/or other modules.

The device module may be configured to a device having a human interface for inputting user-determined criteria, a memory on which processor executable instructions be stored, a processor in communication with the human interface and the memory, and a display for displaying the personalized score by a system server, the system server configured for analyzing the user-determined criteria and for generating the personalized score, the system server in communication with the device through a wide area network. The user permitting module may be configured to permit a user, by human interface of the device, to input the user-determined criteria including psychographic data, editorial data, and syntax data. The criteria transmitting module may be configured to transmit the user-determined criteria from the device to the system server. The score creating module may be configured to create, by the system server, the personalized score based on user-determined criteria. Score transmitting module may be configured to transmit the personalized score from the system server to the device through the wide area network. The display generating module may be configured to generate a display of the personalized score on the display of the device, the display of the personalized score including a visual blueprint of the psychographic data, the editorial data, and the syntax data. Information providing module may be configured to provide, by the device, information to the user regarding the personalized score and allowing for user feedback and management of the user-determined criteria.

In some cases, the step of permitting the user further includes permitting the user to input additional user-determined criteria using surveys, questionnaires, and other user-controlled assessment tools to convey information relating to preferences, requirements, qualifications, experiences, and connections. A step of permitting the user to select which user-determined criteria may be included in the personalized score may also be included.

In another example embodiment, a method may include providing a device having a human interface for inputting user-determined criteria, a memory on which processor executable instructions being stored, a processor in communication with the human interface and the memory, and a display for displaying the personalized score by a system server, the system server configured for analyzing the user-determined criteria and for generating the personalized score. The system server may be in communication with the device through a wide area network. The method may include permitting a user, by human interface of the device, to input the user-determined criteria including psychographic data, editorial data, and syntax data. The method may include transmitting the user-determined criteria from the device to the system server. The method may include creating, by the system server, the personalized score based on user-determined criteria. The method may include transmitting the personalized score from the system server to the device through the wide area network. The method may include generating a display of the personalized score on the display of the device, the display of the personalized score including a visual blueprint of the psychographic data, the editorial data, and the syntax data. The method may include providing, by the device, information to the user regarding the personalized score and allowing for user feedback and management of the user-determined criteria.

In another example embodiment, a system configured for matching a seller and a buyer may include one or more computing platforms. The one or more remote computing platforms may be communicably coupled with one or more remote platforms. In some cases, users may access the system via remote platform(s). The one or more computing platforms may be configured by machine-readable instructions. Machine-readable instructions may include modules. The modules may be implemented as one or more of functional logic, hardware logic, electronic circuitry, software modules, and the like. The modules may include one or more of a device module, a buyer permitting module, a criteria transmitting module, a profile creating module, a profile transmitting module, a display generating module, an information providing module, and/or other modules.

The device module may be configured to a device having a human interface for inputting buyer-determined criteria, a memory on which processor executable instructions be stored, a processor in communication with the human interface and the memory, and a display for displaying the buyer personalized profile by a system server. The system server may be configured for analyzing the buyer-determined criteria and for generating the buyer personalized profile. The system server may be in communication with the device through a wide area network. The buyer permitting module may be configured to permit the buyer, by human interface of the device, to input the buyer-determined criteria. The criteria transmitting module may be configured to transmit the buyer-determined criteria from the device to the system server. The profile creating module may be configured to create, by the system server, the buyer personalized profile based on buyer-determined criteria. The profile transmitting module may be configured to transmit the buyer personalized profile from the system server to the device through the wide area network. The display generating module may be configured to generate a display of the buyer personalized profile on the display of the device, the display of the buyer personalized profile including a visual plan of the buyer-determined criteria. The information providing module may be configured to provide, by the device, information to the buyer regarding the buyer personalized profile and allowing for buyer feedback and management of the buyer personalized profile.

The step of permitting the buyer further includes permitting the buyer to input additional buyer-determined criteria using surveys, questionnaires, and other buyer-controlled assessment tools to convey information relating to preferences, requirements, needs, experiences, events, and opportunities. A step of permitting the buyer to select which buyer-determined criteria may be included in the buyer personalized profile may be provided, as well as permitting the display of the seller personalized score to be viewed by the buyer. The display of the personalized profile may be viewed by the seller and the seller may be an artist and the buyer may be a brand.

In another example embodiment, a method may include providing a device having a human interface for inputting buyer-determined criteria, a memory on which processor executable instructions being stored, a processor in communication with the human interface and the memory, and a display for displaying the buyer personalized profile by a system server. The system server may be configured for analyzing the buyer-determined criteria and for generating the personalized profile. The system server may be in communication with the device through a wide area network. The method may include permitting the buyer, by human interface of the device, to input the buyer-determined criteria. The method may include transmitting the buyer-determined criteria from the device to the system server. The method may include creating, by the system server, the buyer personalized profile based on buyer-determined criteria. The method may include transmitting the buyer personalized profile from the system server to the device through the wide area network. The method may include generating a display of the buyer personalized profile on the display of the device, the display of the buyer personalized profile including a visual plan of the buyer-determined criteria. The method may include providing, by the device, information to the buyer regarding the buyer personalized profile and allowing for buyer feedback and management of the buyer personalized profile.

The method may be performed by one or more hardware processors configured by machine-readable instructions. The method may be configured to be implemented by various modules, as determined by one of skill in the art.

In an example embodiment, an invite-only platform or website may be used by the seller and the buyer. One or both of the seller and the buyer may be invited to participate, or may pay a fee or subscription to participate. The platform may be free to certain sellers and buyers meeting certain criteria. Access to the platform may vary for sellers and buyers depending on fees, subscriptions, the seller personalized score, the buyer personalized profile, or any other suitable measure. A service fee may be collected from one or both of the seller and the buyer for partnerships formed and or fulfilled based on the matching process.

The platform may function in place of or in combination with third party talent representatives, attorneys, banks or other money-transferring agencies, vendors, and related business brokers. The platform may include standard agreements for use by the sellers and the buyers such as MSA and SOW documents, as non-limiting examples. Management teams may use the platform for internal organization and communication with respect to the seller, the buyer, and past, present, and future projects. Sellers and buyers may use the platform as CRM technology for managing all aspects of business. Advantageously, syntax, editorial, and psychographic data compiled using the platform and associated AI, as well as the seller input and buyer input, may uniquely and more accurately match sellers with buyers without the expense and hassle of subjective, limited, and unreliable third parties. Sellers and buyers may engage in communication and exchange of services and compensation in a most efficient, cost-effective manner.

Artists may be invited and/or vetted by a predetermined group of individuals, businesses, and/or peers, as non-limiting examples. Likewise, artists may be invited and/or vetted using predetermined criteria based on selected data points or other objective or subjective information. Brands may be invited to join the platform based on a record of or commitment to spending relating to product placement, talent sponsorship, sales, and any other suitable categories. Direct communication between artists and brands may advantageously facilitate optimal and efficient partnerships, foster more meaningful relationships, improve communication and negotiations, and result in more lucrative and fulfilling outcomes for the artists and the brands. Advantageously, brands will have access to a wider range of artists and more detailed information with respect to each artist and how an artist may positively impact brand marketing, events, and representation.

The seller, such as an artist participating on the platform, may curate a personal webpage highlighting their personalized score formulated using AI relating to the syntax data, editorial data, psychographic data, and first party information provided by the seller. Non-limiting examples of first party data may include a list of brands the seller represents, information about industries the seller is actively involved with, geographic information, personal information relating to interests, hobbies, personality and attitudes, talent, skills, experience, experience within specified industries, past projects, objective and subjective measures of past and present success, background, opinions, demographics, or any other desired data in the form of survey, personal essay, endorsements from other sellers, buyers or third parties, or any other suitable means. The seller may also be able to include and/or input desirable syntax, editorial, and psychographic data as well in order to optimize the personalized score. Subjective and objective data collected from third parties may also be used to create the personalized score. Social data from one or more outside platforms and other varied data resources may also be used to formulate the personalized score. As another non-limiting example, binomial data may also be used to formulate the personalized score. The sellers personalized score may be enhanced based on interactions, events, and partnerships with other sellers and/or buyers accredited on the platform. Likewise, the matching process may be enhanced if more than one seller and/or buyer co-signs onto a project, opportunity, or partnership. The personalized score may include a combination of forced multipliers based on pre-determined data sets, as well as first party data provided by the seller.

The seller may be able to include or remove specific data sets used to formulate the personalized score, as desired. Alternatively, the personalized score may be based on predetermined criteria, but the seller may be able to curate the webpage displaying the personalized score so as to highlight areas of strength while deemphasizing and/or eliminating areas of concern. Certain data may be required for formulation of the personalized score.

The seller may determine what the buyer is able to see. The seller may include information about upcoming projects and opportunities for brands to be involved with. As one non-limiting example, a musical artist may include in their profile an upcoming music video and provide information to brands about specific product placement opportunities. Information about upcoming projects may include who is involved, budget, corresponding events and marketing opportunities, projected sales, target audience, and any other suitable information. The platform may be used as a marketing tool by one or both of the seller and the buyer. Buyers may express interest in certain seller projects and/or initiate communication with a desired seller on upcoming projects. Likewise, sellers may reach out to buyers about upcoming projects.

The buyer, such as a brand, may include information about the brand and/or specific opportunities available from the buyer that a seller may express interest in using the buyer personalized profile. The buyer may also indicate what type of seller the buyer is looking for in general or for specific opportunities. The buyer personalized profile may be used to inform potential sellers about the buyer in order to optimize potential partnerships. Additionally, the buyer personalized profile may be used to inform potential sellers regarding logistical items relating to opportunities such as geographical and monetary requirements, as non-limiting examples.

Additionally, the platform may be used by one or both of the seller and the buyer to market certain aspects of the seller or buyer business, organize projects, attract partners, advertise upcoming projects, communicate with potential and existing partners, communicate internally within teams and companies, and track associated monetary items. One or both of the seller and the buyer may utilize the seller personalized score in combination with a buyer personalized profile to formulate a quantitative and/or qualitative assessment of how successful a partnership may be. Sellers and buyers may be categorized and searchable based on events, industry, location, opportunities, marketing information, or any other suitable means. Advantageously, the personalized score and buyer personalized profile may reduce the risk of suboptimal partnerships for sellers and buyers by providing more personal and relevant information and better informing each party. Additionally, sellers and buyers may self-promote and advertise opportunities relating to existing and potential products, events, and other opportunities. The direct, business-to-business platform eliminates the need for third party involvement and reduces the likelihood of miscommunication that can lead to mismatches and otherwise suboptimal partnerships. Additionally, less money is wasted in industries such as advertising, product placement, and sponsorship, as non-limiting examples, which means greater payoffs for the sellers and the buyers participating in the platform. The personalized score for the seller may be reformulated for each seller or buyer opportunity such that the match process between a seller and a buyer is accurate and specific to a specific engagement or project. Sellers and buyers may be able to select or place additional emphasis on desired data points when formulating the personalized score. Alternatively, a set algorithm may be used to formulate the personalized score taking into account seller data and/or buyer data.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B illustrate a system configured for creating a matching score, according to one embodiment of the present disclosure.

FIGS. 2A and 2B illustrate a method for creating a matching score, according to one embodiment of the present disclosure.

FIGS. 3A and 3B are schematic illustrations describing a process executed according to the method of FIGS. 2A and 2B according to one embodiment of the present disclosure.

FIGS. 4A and 4B illustrate a system configured for dynamic and layered promotion, according to one embodiment of the present disclosure.

FIGS. 5A, 5B, 5C, and 5D illustrate a method for dynamic and layered promotion, according to one embodiment of the present disclosure.

FIG. 6 is a schematic illustration of a layered promotion model for use with the system of FIGS. 4A and 4B, and for use with the method of FIGS. 5A, 5B, 5C, and 5D, according to one embodiment of the present disclosure.

FIG. 7 is a schematic illustration describing a process executed according to the method of FIGS. 5A, 5B, 5C, and 5D, including formation of an authorized programmatic audience and using means for audience enrichment.

FIG. 8 is a schematic illustration describing a process engagement of the authorized programmatic audience and having a seller-controlled or authorized programmatic relay.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The present technology improves the process of matching a seller and a buyer using a matching score. In one non-limiting example, the seller may be an artist and the buyer may be a brand. The matching score may be formulated using any desired combination of datasets such as zero party datasets, third party datasets, and additional datasets. Datasets may be collected and/or provided by one or more zero parties, third parties, administrative parties, artificial intelligence models such as large language models (LLM), neural networks, and any combination thereof, as non-limiting examples. Datasets may also be interpretated, interrogated, manipulated, and otherwise analyzed by sellers, buyers, third parties, administrators, artificial intelligence models, and any combination thereof, as non-limiting examples.

The matching score may be an indicator of compatibility between the seller and the buyer with respect to a project, field, industry, or any other opportunity or arrangement. The purpose of the matching score may be to facilitate an optimal two-sided marketplace capable of matching one or more sellers with one or more buyers. Sellers and buyers may be individuals, groups, businesses, non-profits, and any combination thereof seeking goods, services, partnerships, and/or other opportunities in any suitable industry or combination of industries. The matching score may be determined by analyzing, manipulating, and comparing one or more seller-specific datasets with one or more buyer-specific datasets. In certain embodiments, one or more algorithms may be used to evaluate and compare seller-specific datasets and the buyer-specific datasets to determine the matching score.

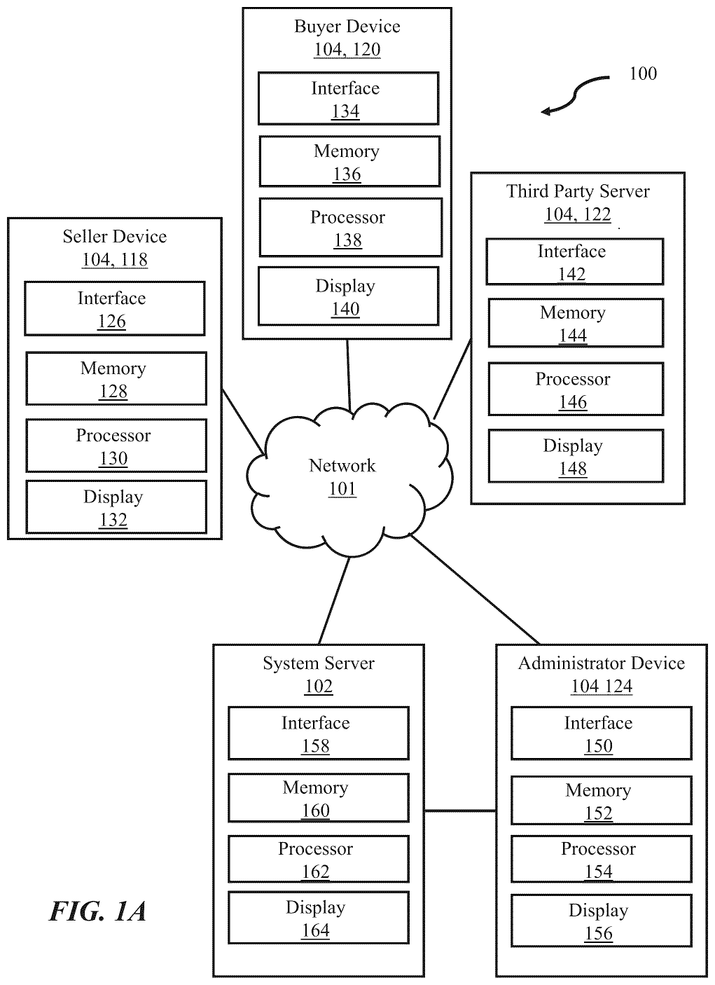

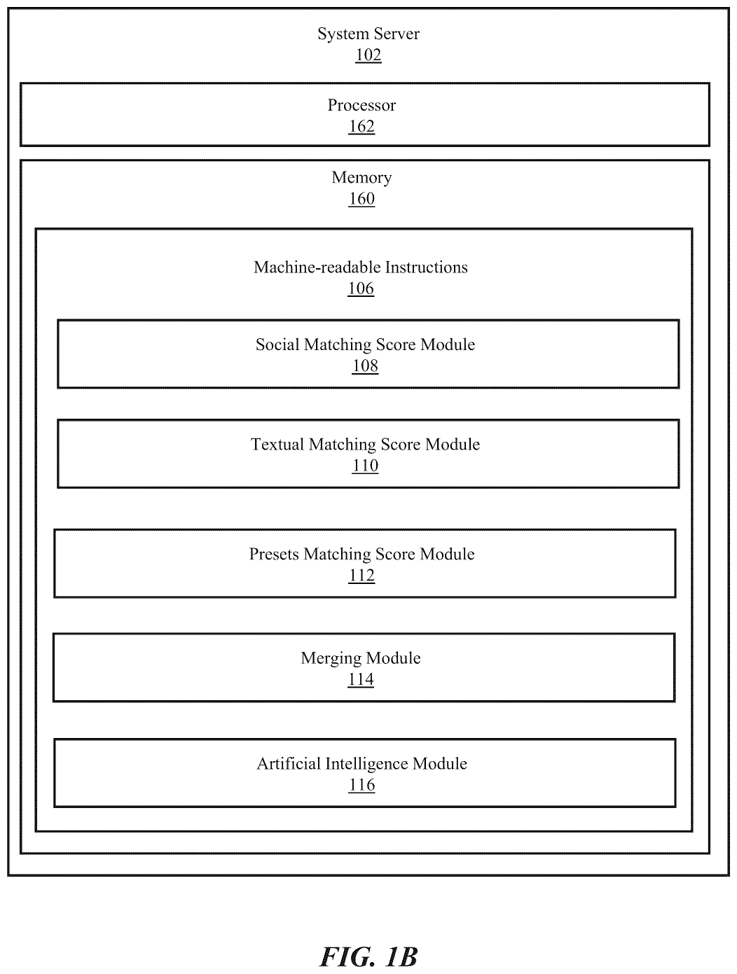

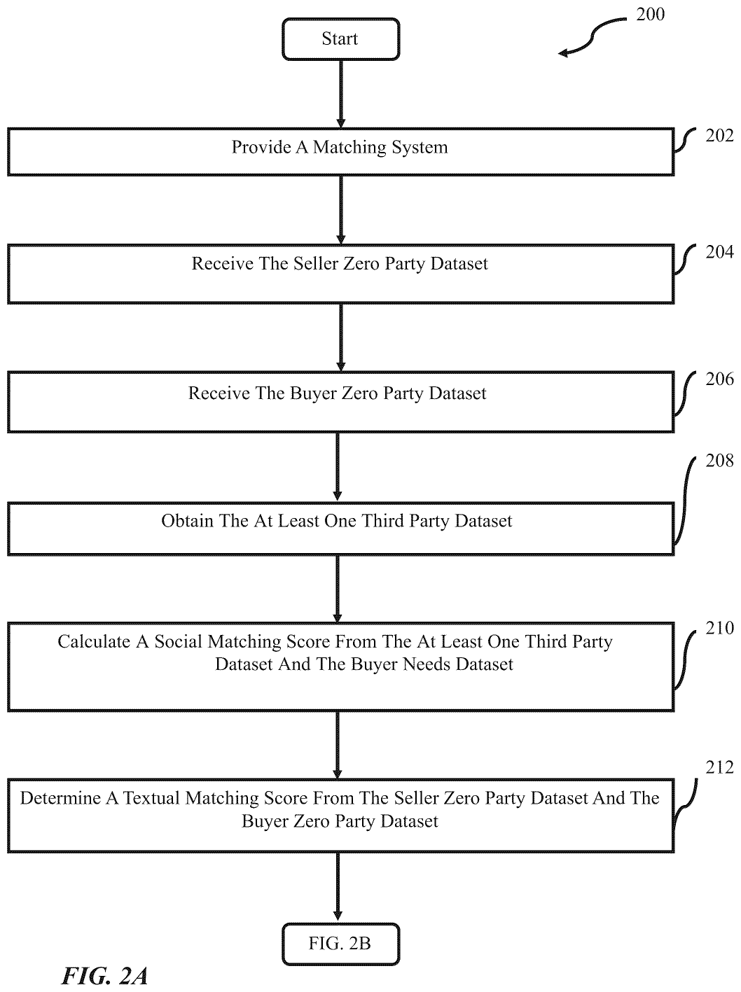

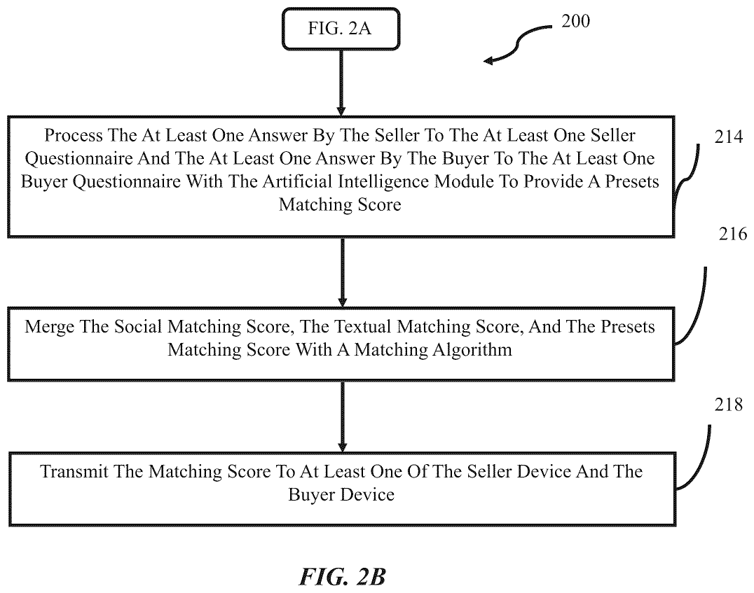

FIGS. 1A and 1B illustrate a system 100 configured for creating a match score, for example, by a method 200 as shown in FIGS. 2A and 2B, and in accordance with one or more embodiments. In some cases, the system 100 may include a one or more computing platforms in the form of at least one system server 102. The at least one system server 102 may be communicably coupled with a plurality of remote platforms 104, for example, via at least one network 101. In some cases, users may access the system 100 via the plurality of remote platforms 104. It should be appreciated that, depending on the situation, the at least one system server 102 may therefore be provided as either a standalone system or a distributed system with the steps distributed across more than one platform.

In some cases, the one or more computing platforms 102, may be communicatively coupled to the remote platforms 104. In some cases, the communicative coupling may include communicative coupling through a networked environment such as the at least one network 101. The networked environment may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platforms 104 may be operatively linked via some other communication coupling. The one or more computing platforms 102 may be configured to communicate with the at least one network 101 via wireless or wired connections. In addition, in an embodiment, the system 100 may also include one or more hosts or servers, such as the at least one system server 102 connected to the network 101 through wireless or wired connections. According to one embodiment, the at least one system server 102 may be implemented in or function as base stations (which may also be referred to as Node Bs or evolved Node Bs (eNBs)). In other embodiments, the at least one system server 102 may include web servers, mail servers, application servers, etc. According to certain embodiments, the at least one system server 102 may be standalone servers, networked servers, or an array of servers. In an embodiment, the plurality of remote platforms 104 may be configured to communicate directly with each other via wireless or wired connections. Examples of the plurality of remote platforms 104 may include, but are not limited to, smartphones, wearable devices, tablets, laptop computers, desktop computers, Internet of Things (IoT) devices, or other mobile or stationary devices.

Referring again to FIGS. 1A and 1B, the at least one system server 102 may be configured by machine-readable instructions 106. The machine-readable instructions 106 may include modules. In this aspect, the method 200 as shown in FIGS. 2A and 2B may be configured to be implemented by the modules, which in turn may be implemented as one or more of functional logic, hardware logic, electronic circuitry, software modules, and the like.

As illustrated in FIGS. 1A and 1B, the modules may include one or more of a social matching score module 108, a textual matching score module 110, a presets matching score module 112, a merging module 114, an artificial intelligence module 116, and/or other modules.

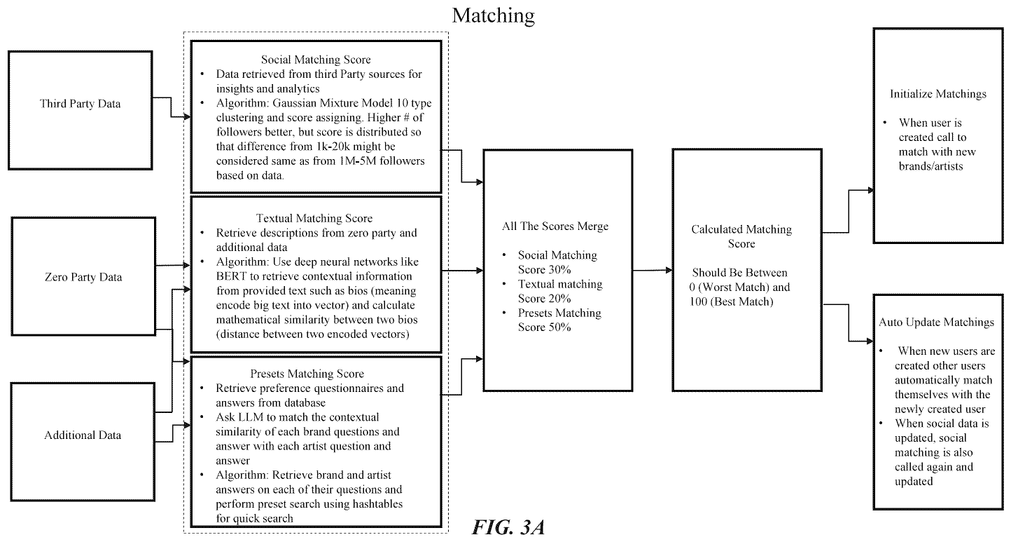

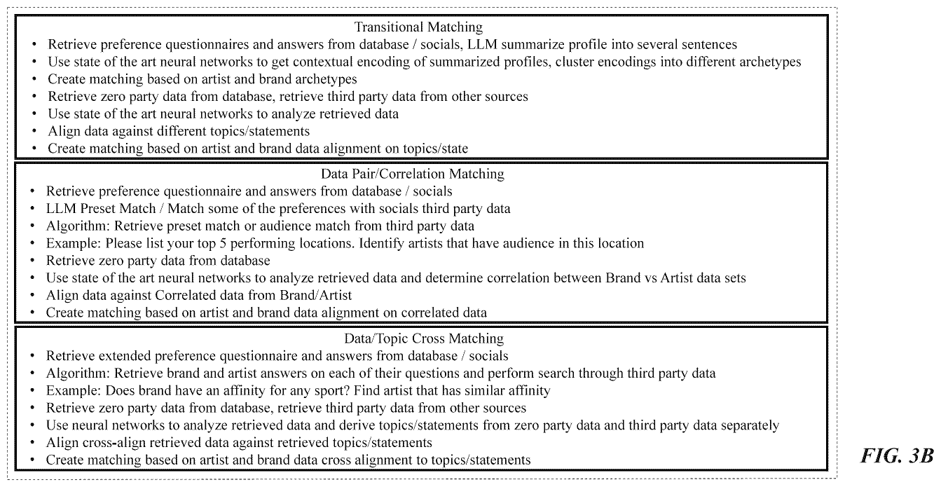

In particular, and according to various embodiments of the present disclosure, the at least one system server 102 may constitute a matching score model system involving matching score model, for example, as illustrated schematically in FIGS. 3A and 3B. More specifically, FIG. 3B includes various examples that may fall under the section of FIG. 3A called out in broken lines. The plurality of remote platforms 104 may include a seller device 118, a buyer device 120, at least one third party server 122, and an administrator device 124 for example. One of ordinary skill in the art may also select suitable types of hardware for each of the seller device 118, the buyer device 120, the at least one third party server 122, the administrator device 124, and any additional computer devices (not shown), within the scope of the present disclosure.

As shown in FIGS. 1A and 1B, the seller device 118 may have a seller device human interface 126, a seller device memory 128, a seller device processor 130, and a seller device display 132. The seller device human interface 126 may be configured for use by a seller and for providing at least a seller zero party dataset. The seller zero party dataset may include at least one answer by the seller to at least one seller questionnaire. One of ordinary skill in the art may also select any other suitable dataset or information, as desired.

The buyer device 120 has a buyer device human interface 134, a buyer device memory 136, a buyer device processor 138, and a buyer device display 140. The buyer device human interface 134 may be configured for use by a buyer and for providing at least a buyer zero party dataset. The buyer zero party dataset may include at least one answer by the buyer to at least one buyer questionnaire. One of ordinary skill in the art may also select any other suitable dataset or information, as desired.

The at least one third party server 122 may have a third party server human interface 142, a third party server memory 144, a third party server processor 146, and a third party server display 148. The at least one third party server 122 has at least one third party dataset. The at least one third party server human interface 142 is configured for use by a third party, such as a least one of a social media platform, as is described further herein.

With continued reference to FIGS. 1A and 1B, the administrator device 124 has an administrator device human interface 150, an administrator device memory 152, an administrator device processor 154, and an administrator device display 156. The administrator device human interface 150 is configured for use by at least one administrator and for providing at least an administrator dataset. One of ordinary skill in the art may also select any other suitable dataset or information, as desired.

As shown in FIGS. 1A and 1B, the at least one system server 102 may further have a system server human interface 158, a system server memory 160, a system server processor 162, and a system server display 164. The at least one system server 102 is in communication with the seller device 118, the buyer device 120, the at least one third party server 122, and the administrator device 124 through the network 101, as described hereinabove.

It should be appreciated that the server memory 160 of the at least one system server 102 may further include or be coupled to a memory (internal or external), which may be coupled to one or more processors such as the system server processor 162, for storing information and instructions that may be executed by the system server processor 162. The system server memory 160 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, the system server memory 160 can consist of any combination of random-access memory (RAM), read only memory (ROM), static storage such as a magnetic or optical disk, hard disk drive (HDD), or any other type of non-transitory machine or computer readable media. The instructions stored in the system server memory 160 may include program instructions or computer program code that, when executed by the system server processor 162, enable the at least one system server 102 to perform tasks as described herein.

One skilled in the art will also appreciate that one or more processors such as the system server processor 162 of the at least one system server 102 may be configured for processing information and executing instructions or operations. The system server processor 162 may be any type of general or specific purpose processor. In some cases, multiple processors for the system server processor 162 may be utilized according to other embodiments. In fact, the one or more of the system server processor 162 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more of the system server processor 162 may be remote from the at least one system server 102, such as disposed within a remote platform like the one or more remote platforms 104 of FIGS. 1A and 1B.

The one or more processors may perform functions associated with the operation of system 100 which may include, for example, precoding of antenna gain/phase parameters, encoding and decoding of individual bits forming a communication message, formatting of information, and overall control of the one or more computing platforms 102, including processes related to management of communication resources.

In some embodiments, one or more computing platforms 102 may also include or be coupled to one or more antennas (not shown) for transmitting and receiving signals and/or data to and from the at least one system server 102. The one or more antennas may be configured to communicate via, for example, a plurality of radio interfaces that may be coupled to the one or more antennas. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

With renewed reference to FIGS. 1A and 1B, and as described hereinabove, the system server memory 160 stores the plurality of modules including the machine-readable instructions 106, which may be provided as tangible, non-transitory processor executable instructions, as a non-limiting example. The instructions are configured to execute the method 200 of the present disclosure, by the system server processor 162 or the other processors of the system 100 as detailed herein, and as described hereinbelow and shown in FIGS. 2A and 2B.

Referring now to FIGS. 2A and 2B, the method 200 of the present disclosure may further include a first step 202 of providing the system 100 as described hereinabove. In operation, the method 200 also includes a second step 204 of receiving, by the at least one system server 102 from the seller device 118, the seller zero party dataset, and a third step 206 of receiving, by the at least one system server 102 from the buyer device 120, the buyer zero party dataset. The seller zero party dataset may include information provided by the seller, and the buyer zero party dataset may include information provided by the buyer, according to certain embodiments.

Each of the seller zero party dataset and the buyer zero party dataset may include personal information such as biographical or historical information, demographic information, financial information, information relating to physical characteristics, geographic information, educational and professional information, public life information, political affiliations, information relating to online activity and/or social networking, tracking information, personal information relating to religious and philosophical beliefs, opinions, interests, preferences, affinities, affiliations, needs, likes and dislikes, passions, personal identifier information, and behavioral information, as non-limiting examples.

According to certain embodiments, one or both of the seller zero party dataset and the buyer zero party dataset may include data directly relating to a specific project or opportunity or generally relating to personal and/or professional interests, availability, and opportunities. It should be understood that any desirable information may be provided by the seller in the seller zero party dataset and any desirable information may be provided by the buyer in the buyer zero party dataset.

Information for the seller zero party dataset and the buyer zero party dataset may be obtained using questionnaires, surveys, prompts, forms, and any combination thereof, as non-limiting examples, as determined by one of skill in the art. Information included in the seller zero party dataset and the buyer zero party dataset may be categorized and/or organized, as desired. In certain embodiments, the seller zero party dataset may include a specific dataset such as a seller interests dataset, as one non-limiting example, and the buyer zero party dataset may include a specific dataset such as a buyer needs dataset, as one non-limiting example. Each of the seller interests dataset and the buyer needs database may include information relating to a specific or general professional opportunity, such as an advertising or marketing opportunity, as one non-limiting example, or may include more general information.

The system 100 further includes a fourth step 208 of obtaining, by the at least one system server 102 from the at least one third party server 122, the at least one third party dataset. In certain embodiments, the at least one third party dataset may be collected from one or more external data providers and may be used to formulate the matching score. The at least one third party dataset may be directly or indirectly associated with one or both of the seller and the buyer or not associated with either of the seller and the buyer. In certain embodiments, a seller third party dataset may include information directly or indirectly associated with the seller or information that is independent of the seller. A buyer third party dataset may include information directly or indirectly associated with the buyer or information that is independent of the buyer such as a social insight dataset, as one non-limiting example.

The at least one third party dataset may include information collected and analyzed from one or more outsourced websites or other databases, as well as data retrieved using SaaS platforms who provide data analytics designed for industry insights, offering insights and analytics (ie. for music industry: insights and analytics on artists, their songs, and music trends) to help professionals make informed decisions or platforms that provide influencer marketing, campaign management solutions, and social platform insights, helping brands and marketers identify, manage, and collaborate with creators with social media platforms, as non-limiting examples. Marketing, product, behavior, revenue, and any other suitable analytics tools may be used to provide the at least one third party dataset. The at least one third party dataset may be obtained using data marketplaces or any other suitable means, as determined by one of skill in the art.

A fifth step 210 of the method 200 includes calculating, by the social matching score module 108 of the at least one system server 102, a social matching score. According to certain embodiments, the social matching score may be calculated using at least one third party dataset. In certain embodiments, at least one seller third party dataset and at least one buyer zero party dataset, such as the buyer needs dataset, as one non-limiting example, may be used to calculate the social matching score.

The social matching score, according to certain more particular embodiments, may be based on an overall social reach value of the seller. The social reach value may be an indication of fame, in one non-limiting example. A seller third party dataset may include seller social information that is specific to the seller such as a number of followers and/or listeners, a trending score, a daily engagement rate, a list of genres, or any other suitable social information dataset may be used to determine the overall social reach of the seller. The social matching score may be based on at least the overall social reach value of the seller and may be a numerical value between 0 and 100, wherein 0 indicates no fame at all, and 100 indicates the most famous. The social reach value may be general or specific to an audience of the seller such as a group of followers or subscribers. Audience member characteristics such as age, location, and ethnic background, as non-limiting examples, may be identified and/or categorized, as desired. Each category may result in a separate social reach value, according to certain embodiments. In certain embodiments, an absolute value may include a number of followers, as one non-limiting example, and a normalized value may include the numerical value between 0 and 100 that reflects an indication of fame. The indication of fame may be a general indication of fame based on an overall absolute value or a more specific indication of face based on a particular category of audience.

It should be appreciated that the social matching score may be calculated using any combination of at least one third party dataset, at least one seller zero party dataset, and at least one buyer zero party dataset, as determined by one of skill in the art.

The method 200 further includes a sixth step 212 of determining, by the textual matching score module 110 of the at least one system server 102, a textual matching score from at least the seller zero party dataset and the buyer zero party dataset. The sixth step 212 may include analyzing, by the textual matching score module 110, at least one seller textual description and at least one buyer textual description included in the buyer zero party dataset with the artificial intelligence module 116, according to certain embodiments. In certain embodiments, a seller zero party dataset including a textual description and a buyer zero party dataset including a textual description may be used to determine the textual matching score using the artificial intelligence module 116 to determine a degree of alignment based on the textual descriptions. In certain embodiments, a seller third party dataset such as a textual description of the seller obtained by a third party, as one non-limiting example, and a buyer third party dataset such as a textual description of the buyer obtained by a third party, as one non-limiting example, may be used to determine the textual matching score using the artificial intelligence module 116 to determine a degree of alignment based on the textual descriptions. In one non-limiting example, the at least one third party server 122 may provide a seller third party dataset and a buyer third party dataset, and the textual matching score may be calculated using the seller zero party dataset, the buyer zero party dataset, the seller third party dataset, and the buyer third party dataset. It should be appreciated that any number of seller zero party datasets, buyer zero party datasets, third party datasets, and combinations thereof may be used to calculate the textual matching score, as determined by a skilled artisan.

A seventh step 214 includes processing, by the presets matching score module 112 of the at least one system server 102, a presets matching score. In certain embodiments, seventh step 214 includes processing, by the presets matching score module 112 of the at least one system server 102, the at least one answer by the seller to the at least one seller questionnaire and the at least one answer by the buyer to the at least one buyer questionnaire with the artificial intelligence module 116 to provide the presets matching score.

According to certain embodiments, additional datasets may be used to formulate the presets matching score. Additional datasets may be directly or indirectly associated with one or both of the buyer and the seller and/or not associated with one or both of the buyer and the seller. Seller additional datasets may include information directly or indirectly associated with the seller or information that is independent of the seller. Buyer additional datasets may include information directly or indirectly associated with the buyer or information that is independent of the buyer.

In certain more particular embodiments, additional datasets may be directly or indirectly compared with one or more predetermined datasets and used to calculate the presets matching score. Predetermined datasets may include predetermined questions and/or predetermined answers and/or combinations of answers selected using one or both of the artificial intelligence module 116 and/or the administrator.

Additional datasets and/or predetermined datasets may include information collected, generated, summarized, analyzed, interrogated, or otherwise manipulated using one or both of a deep learning model such as a large language model (LLM), neural network, or artificial intelligence algorithm, as non-limiting examples, and the administrator, as determined by one of skill in the art. In certain embodiments, one or both of the artificial intelligence module 116 and the administrator may collect, generate, summarize, analyze, interrogate, or otherwise manipulate seller zero party datasets, buyer zero party datasets, seller third party datasets, buyer third party datasets, seller additional datasets, buyer additional datasets, predetermined datasets, and any combination thereof and compare one or more of the seller zero party datasets, buyer zero party datasets, seller third party datasets, buyer third party datasets, seller additional datasets, buyer additional datasets, predetermined datasets to generate the presets matching score using one or more algorithms, predetermined algorithms, and/or any other suitable means.

According to certain more particular embodiments, the predetermined datasets may include dataset such as at least one seller question that is included in the at least one seller questionnaire, at least one predetermined seller answer to the at least one seller question, at least one buyer question that is included in the at least one buyer questionnaire, and at least one predetermined buyer answer to the at least one buyer question. The at least one buyer question may correspond with the at least one seller question, and at least one of the administrator and the artificial intelligence module 116 may provide at least one predetermined seller-buyer answer combination having a predetermined score associated with the predetermined seller-buyer answer combination. Using the artificial intelligence module 116, the step of processing the at least one answer by the seller and the at least one answer by the buyer may further include calculating the presets matching score for an actual seller-buyer answer combination by assigning the predetermined score associated with the predetermined seller-buyer answer combination that is same as the actual seller-buyer answer combination. It should be appreciated that the predetermined score associated with the predetermined seller-buyer answer combination may be included in one or more predetermined datasets, and the one or more predetermined datasets may be compared with one or more additional dataset to calculate the presets matching score. Any suitable comparison between seller zero party datasets, buyer zero party datasets, seller third party datasets, buyer third party datasets, seller additional datasets, buyer additional datasets, and predetermined datasets may be used to calculate the presets matching score, as determined by one of skill in the art.

In an eighth step 216, the merging module 114 of the at least one system server 102 merges the social matching score, the textual matching score, and the presets matching score using the merging algorithm to provide the matching score between the seller and the buyer. In certain embodiments, the matching score may be an indicator of a degree of alignment between the seller and the buyer. The matching score may be a weighted average of at least the social matching score, the textual matching score, and the presets matching score according to certain embodiments. The matching score may be calculated using seller zero party datasets, buyer zero party datasets, seller third party datasets, buyer third party datasets, seller additional datasets, buyer additional datasets, and any combination thereof, as determined by one of skill in the art. According to certain embodiments, seller zero party datasets, buyer zero party datasets, seller third party datasets, buyer third party datasets, seller additional datasets, buyer additional datasets, and any combination thereof may be combined, analyzed, interrogated, and otherwise manipulated using the artificial intelligence module 116 and/or to the matching module to formulate the matching score. The matching score may be an indicator of the degree of alignment of the buyer and the seller with respect to at least one of a project, field, industry, opportunity, and/or arrangement, as desired.

In certain embodiments, any number of seller zero party datasets, buyer zero party datasets, seller third party datasets, buyer third party datasets, seller additional datasets, buyer additional datasets, and any combination thereof may be provided, combined, analyzed, interrogated, and otherwise manipulated by the administrator, and one or more of the social matching score, the textual matching score, the presets matching score, and the matching score, may be curated and/or amended by the administrator using the artificial intelligence module 116, the merging module 114, and/or any other suitable means such as providing administrator curated datasets and/or administrator predetermined scores, as non-limiting examples.

In certain embodiments, seller zero party datasets, buyer zero party datasets, seller third party datasets, buyer third party datasets, seller additional datasets, buyer additional datasets, and any combination thereof may be provided by at least one of the seller, the buyer, the administrator, the artificial intelligence module 116, at least one third party individual, and/or at least one third party organization. In one non-limiting example, one or more individuals or companies may complete a survey or questionnaire about the seller and/or the buyer, and the survey or questionnaire may be used as at least one third party dataset and/or as an additional dataset. In one more particular embodiment, one or more companies and/or individuals may complete a questionnaire about a seller including questions directed to the seller's reputation. The results of the questionnaire may be used as at least one seller third party dataset and/or as at least one seller additional dataset and may provide an indication as to how the buyer is perceived by a wider audience. In other non-limiting examples, one or more psychographic datasets may be used in specific correlation to survey group datasets, one or more editorial datasets may be obtained using artificial intelligence algorithms and/or predetermined algorithms, and/or one or more syntax datasets indicating a sentiment of an audience of one or both of the seller and the buyer may be used to formulate the matching score. It should be appreciated that one or more algorithms which may include datasets such as syntax datasets, editorial datasets, psychographic datasets, zero party datasets, third party datasets, additional datasets, and any combination thereof may be used to determine the matching score.

In one more particular embodiment, if a seller is interested in a buyer, has spoken about the buyer in social media or in traditional media (syntax data), the seller's audience says that the seller is a good fit with or representative for the buyer (psychographic data), and several other influential persons have noted that the seller is a good fit with or representative for the buyer (editorial data), a unique dataset may be established and included in the calculation of the matching score.

According to certain embodiments, predetermined matching algorithms associated with a specific opportunity, request, need, interest, or other criteria for one or both of the seller and the buyer may be used to determine which datasets are used to formulate the matching score. In one non-limiting example, a first predetermined algorithm may be employed to determine the matching score where the buyer and the seller are engaging one another in the field of marketing, and a second predetermined algorithm may be employed to determine the matching score where the buyer and the seller are engaging one another in the field of finance.

The method 200 includes a ninth step 218 of transmitting the matching score from the at least one system server 102 to at least one of the seller device 118, the buyer device 120, and the administrator device 124. Advantageously, the matching score may be used by the seller, the buyer, the administrator, and/or one or more third parties to understand and utilize a degree of alignment between one or more seller and buyers and to thereby make informed decisions with respect to forming partnerships.

It should be appreciated that ongoing updates using seller zero party datasets, buyer zero party datasets, seller third party datasets, buyer third party datasets, seller additional datasets, buyer additional datasets, survey datasets, administrator datasets, and any combination thereof may be used to calculate the matching score. The system 100, using any suitable module, may update, match, and machine learning automatically and/or on a predetermined and/or constant basis. It should be appreciated that the administrator may be directly or indirectly involved in any updating, matching, and machine learning, as desired. Initial matching score modules and auto-update matching score modules, as non-limiting examples may be used to generate and update new and preexisting matching scores. Additionally, one or both of the artificial intelligence module and the administrator may increase or decrease a weight of one or more of the social matching score, the textual matching score, and the presets matching score, if the accuracy the associated social matching score, the textual matching score, and/or the presets matching score is in question, according to certain embodiments. Likewise, according to certain embodiments, one or both of the seller and the buyer may increase or decrease a weight of one or more of the social matching score, the textual matching score, and the presets matching score, as desired.

It should further be appreciated that additional steps may be included in the method 200, as determined by one of skill in the art. As non-limiting examples, various steps relating to the social matching module, the textual matching module, the presets matching module, the artificial intelligence module 116, and the merging module 114 may be included. Steps relating to datasets curated by the administrator may also be included, according to certain embodiments. The method 200 may also include repeating or omitting various steps, as needed.

Although the present disclosure is described primarily with respect to the system 100 and method 200, it should be appreciated that, being computer-implemented in scope, the system and method both also have a non-transient computer-readable storage medium in the form of the at least one memory 160 of the system server 102, comprising the instructions being executable by the one or more processors 162 to perform the method 200 as described herein.

### Example 1

Example embodiments of the present technology are provided with particular reference to the FIGS. 3A and 3B enclosed herewith, together with the following remarks.

Introduction:

The system and method for creating a matching score aims to establish a deeper understanding of sellers and buyers using information such as editorial, psychographic, and syntax data, as non-limiting examples, and couple unique datasets such as the seller zero party dataset, the buyer zero party dataset, the third party dataset, or any other desired dataset or combination of datasets, as determined by a skilled artisan, to create a specific informational spectrum that informs a matching score. The matching score establishes global value of sellers and buyers based on evaluatory tools used by sellers and buyers in any number of industries to determine the viability of partnerships and evaluate intangibles to inform various aspects of partnership formation such as valuations, as one non-limiting example.

Advantageously, the system and method of the present disclosure creates a matching score that facilitates a more personal and informed matching strategy by merging the thinking between different datasets and creating a unique artificial intelligence capable of understanding the attributes and intentions of the seller and the buyer involved.

Description:

1) Social Matching Score

As shown in FIG. 3, the system enables third party data such as datasets parsed from outsourced websites and/or retrieved from SaaS platforms for insights and analytics for industry, social media, and trends, as non-limiting examples, to be used to generate the social matching score. The social matching score may be based on the overall social power of the seller and/or a social reach value, according to certain embodiments. Social information about the seller such as a number of followers and/or listeners, trending scores, daily engagement rates, genres, and any other suitable social information is used to match the seller to a buyer according to the buyer needs. The social matching score based on the social power and/or the social reach value of the seller may be a numerical value between 0 and 100, wherein 0 indicates no fame at all, and 100 indicates the most famous.

2) Textual Matching Score

The system and method enable seller zero party data and buyer zero party data including personal information provided by the seller and the buyer to inform the textual matching score. In certain more particular embodiments, textual descriptions given by one or both of the seller and the buyer are processed using artificial intelligence modules and deep learning algorithms to contextually analyze the textual descriptions relative to one another. The textual matching score may be based on how well the textual description from the seller matches the textual description from the buyer. The textual matching score based on the textual descriptions of the seller and the buyer may be a numerical value between 0 and 100, wherein 0 indicates no match at all, and 100 indicates contextually the same.

3) Presets Matching Score

The system and method enable deep learning models such as large language models, nuclear networks, and artificial intelligence models to generate, summarize, and analyze seller and buyer questions and answers. In certain embodiments, preference questionnaires and corresponding answers are generated using artificial intelligence powered language models. In one non-limiting example, a seller question and a buyer question that correspond to one another, and a set of answers corresponding to the seller question and the buyer question, are analyzed using an artificial intelligence model. All possible answer combinations are provided. The artificial intelligence model generates a preset matching score for each answer combination. The preset matching score may be a numerical value between 0 and 100, 0 indicating no match and 100 indicating a perfect match. The preset matching score for each answer combination may then be assigned to an actual seller-buyer answer combination. In certain embodiments, an artificial intelligence module provides at least one predetermined seller-buyer answer combination having a predetermined score associated with the predetermined seller-buyer answer combination. The artificial intelligence module processes an actual seller-buyer answer combination and calculates the presets matching score for the actual seller-buyer answer combination by assigning the predetermined score associated with the predetermined seller-buyer answer combination that is same as the actual seller-buyer answer combination. In certain embodiments, the presets matching score may include one or more scores assigned to comparison of textual descriptions given by one or both of the seller and the buyer that are processed using artificial intelligence modules and deep learning algorithms to contextually analyze the textual descriptions relative to one another.

4) Matching Score

The system and method are also designed to calculate the matching score between the seller and the buyer using at least seller zero party datasets, buyer zero party datasets, third party data, and artificial intelligence modules including matching algorithms. The matching algorithm implements different paradigms to link the seller zero party datasets and the buyer zero party datasets to understand a compatibility and/or a degree of alignment between the seller and the buyer. The matching score may be a numerical value between 0 and 100, with 0 indicating no match at all and 100 indicating a perfect match. The matching score may be calculated using a weighted average of the social matching score, the textual matching score, and the presets matching score, according to certain embodiments.

5) Machine Learning

Various modules such as the social matching score module, the textual matching score module, the presets matching score module, the merging module, and the artificial intelligence module, as non-limiting examples, may be analyzed, improved, evolved, enhanced, and otherwise updated using machine learning and/or additional or new datasets, according to certain embodiments. A new matching score may be automatically generated based on additional or new datasets, as determined by one of skill in the art.

6) Distributed Platform Functionality

While the system can exist as a standalone platform, its functionality may also be distributed across multiple platforms, potentially integrating with third-party service or information platforms.

### Example 2

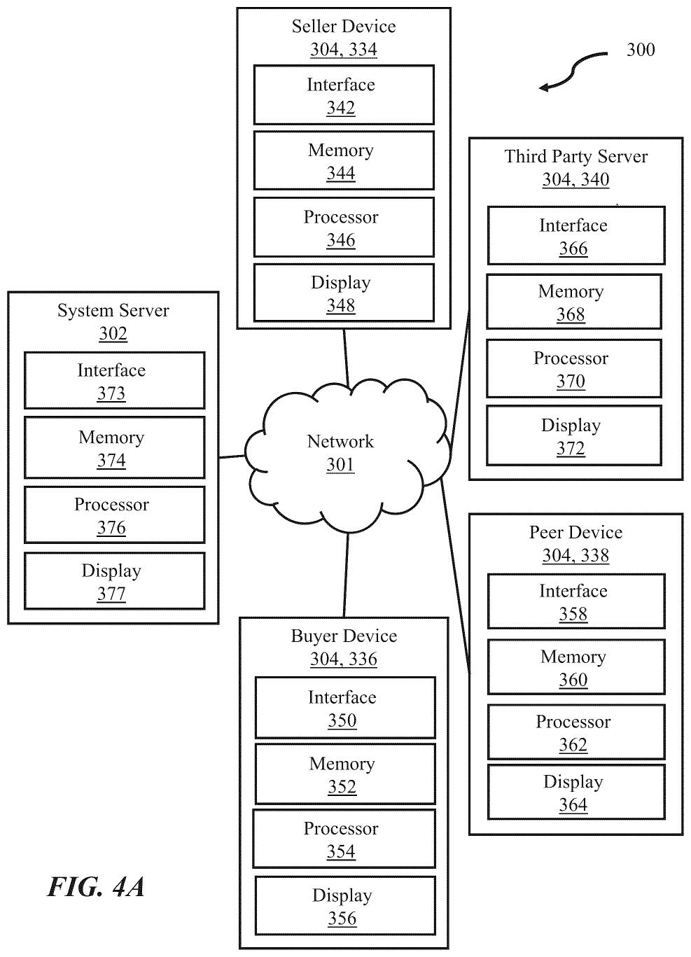

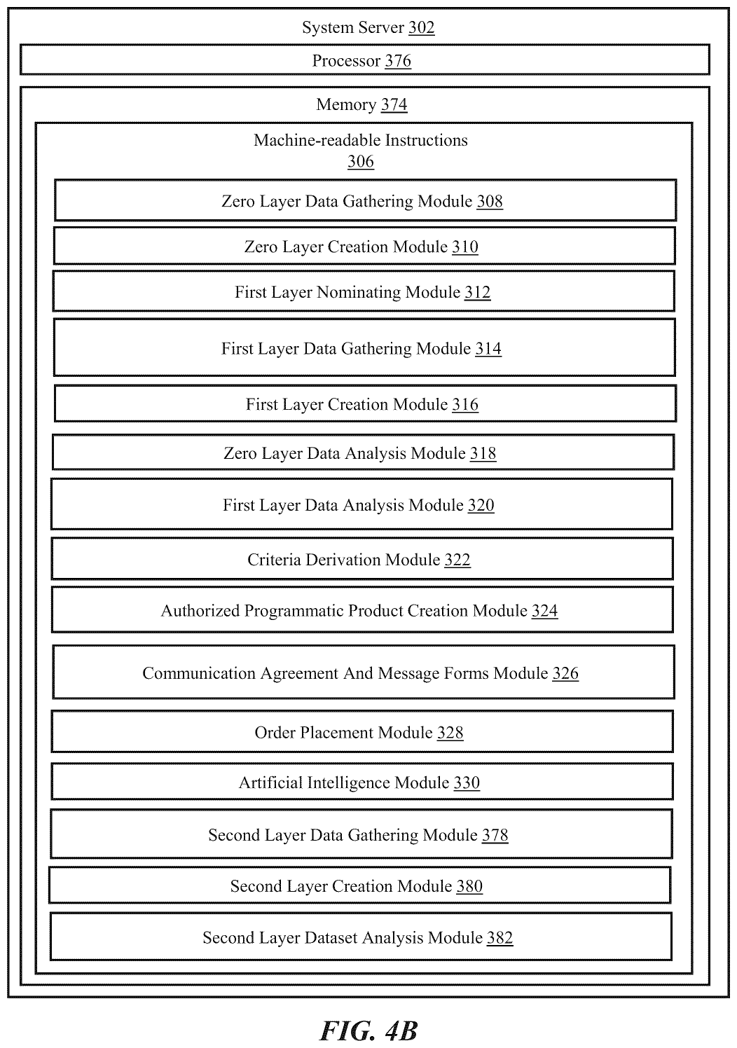

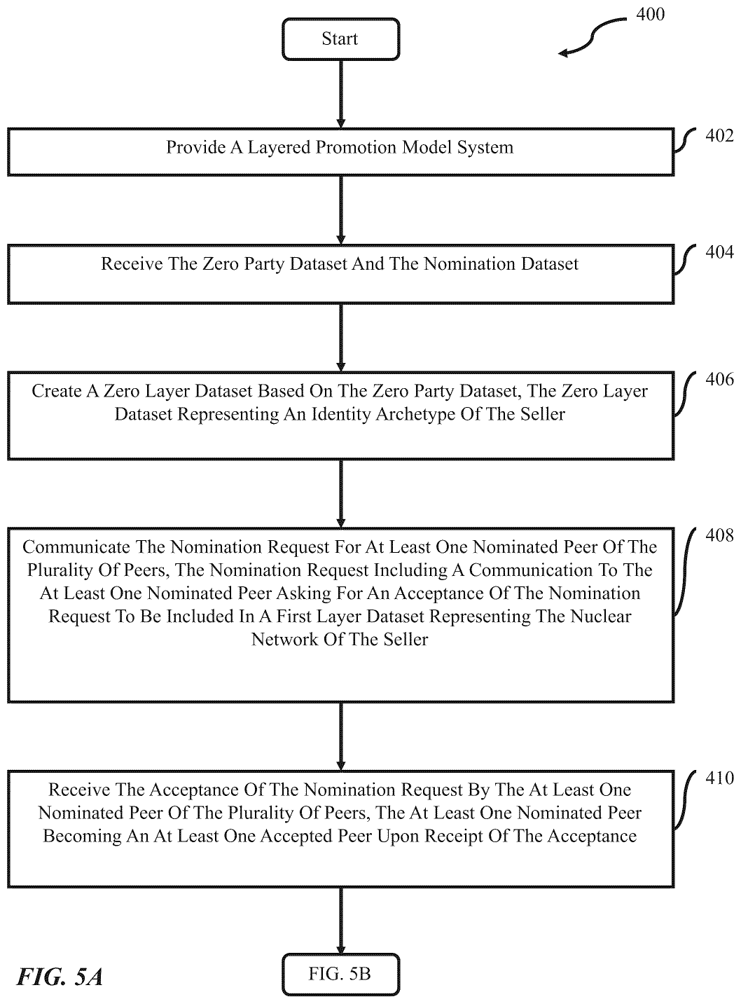

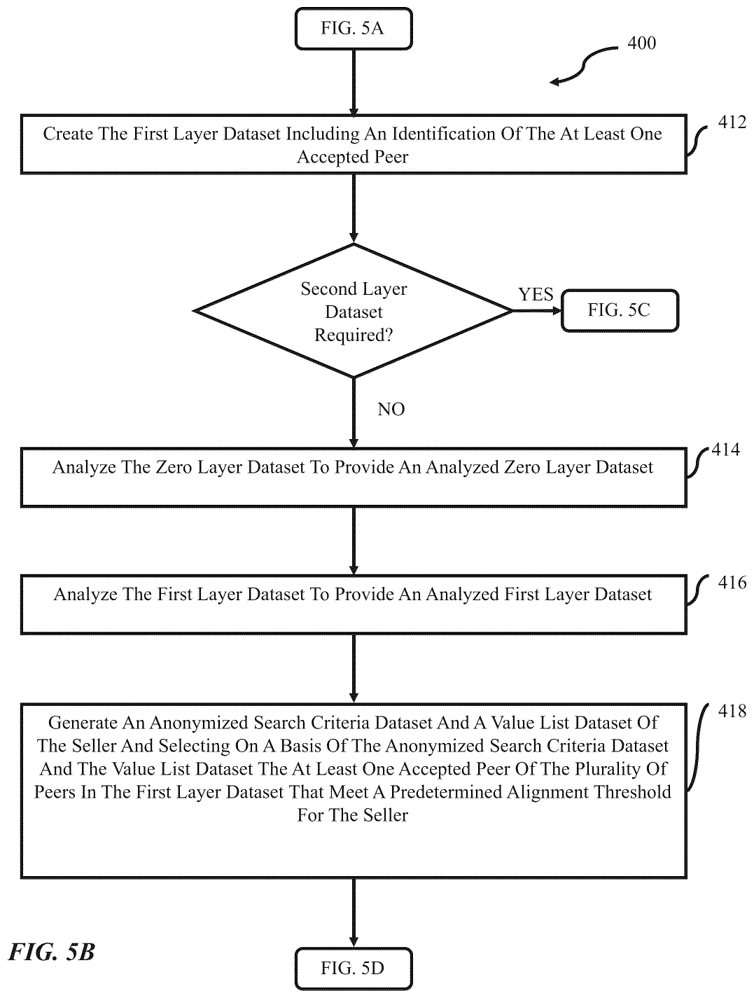

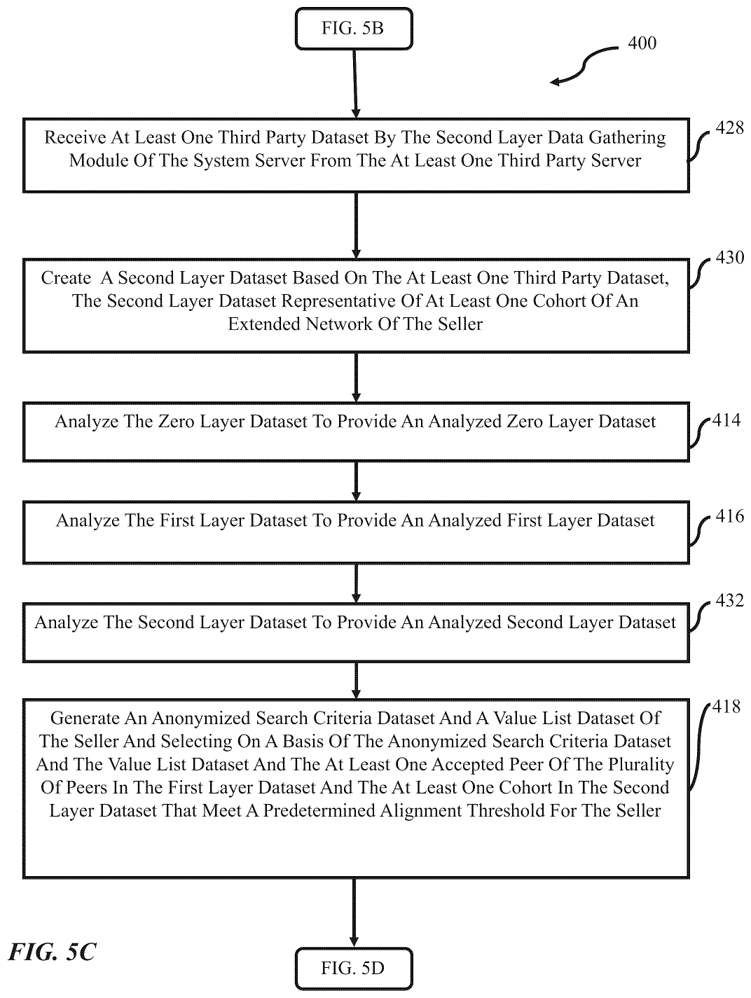

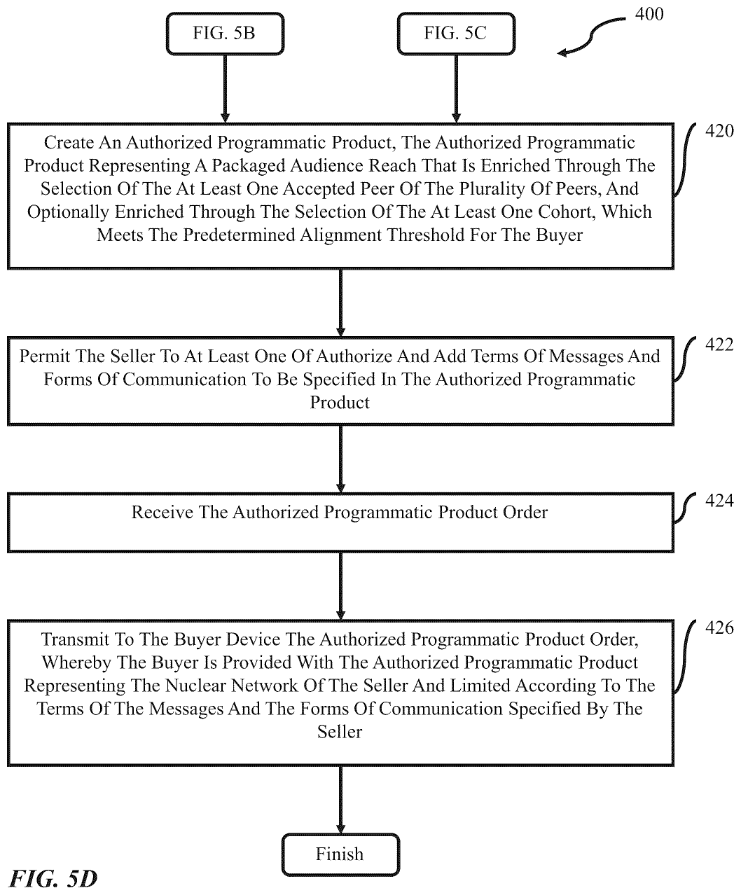

Example embodiments of the present technology are provided with particular reference to the FIGS. 4A-4B and 5A-5D enclosed herewith, together with the following remarks.

According to certain embodiments, the matching score may further indicate a compatibility or degree of alignment between a buyer and at least one of a nuclear network and an extended network of a seller. The technical and hardware descriptions provided above relative to computer platforms, systems, servers, and networks, in relation to the system and method of FIGS. 1-3, can also be applied to the system and method described in the example hereinbelow below, in relation to FIGS. 4A-4B and 5A-5D.

FIGS. 4A and 4B illustrate a system 300 configured for dynamic and layered promotion, for example, by a method 400 as shown in FIGS. 5A to 5D, and in accordance with one or more embodiments. In some cases, the system 300 may include a one or more computing platforms in the form of at least one system server 302. The at least one system server 302 may be communicably coupled with a plurality of remote platforms 304, for example, via at least one network 301. In some cases, users may access the system 300 via the plurality of remote platforms 304. It should be appreciated that, depending on the situation, the at least one system server 302 may therefore be provided as either a standalone system or a distributed system with the steps distributed across more than one platform.

The at least one system server 302 may be configured by machine-readable instructions 306. The machine-readable instructions 306 may include modules. In this aspect, the method 400 as shown in FIGS. 5A to 5D may be configured to be implemented by the modules, which in turn may be implemented as one or more of functional logic, hardware logic, electronic circuitry, software modules, and the like.

As illustrated in FIGS. 4A and 4B, the modules may include one or more of a zero layer data gathering module 308, a zero layer creation module 310, a first layer nominating module 312, a first layer data gathering module 314, a first layer creation module 316, a zero layer data analysis module 318, a first layer data analysis module 320, a criteria derivation module 322, an authorized programmatic product creation module 324, a communication agreement and message forms module 326, an order placement module 328, an artificial intelligence module 330, and/or other modules.

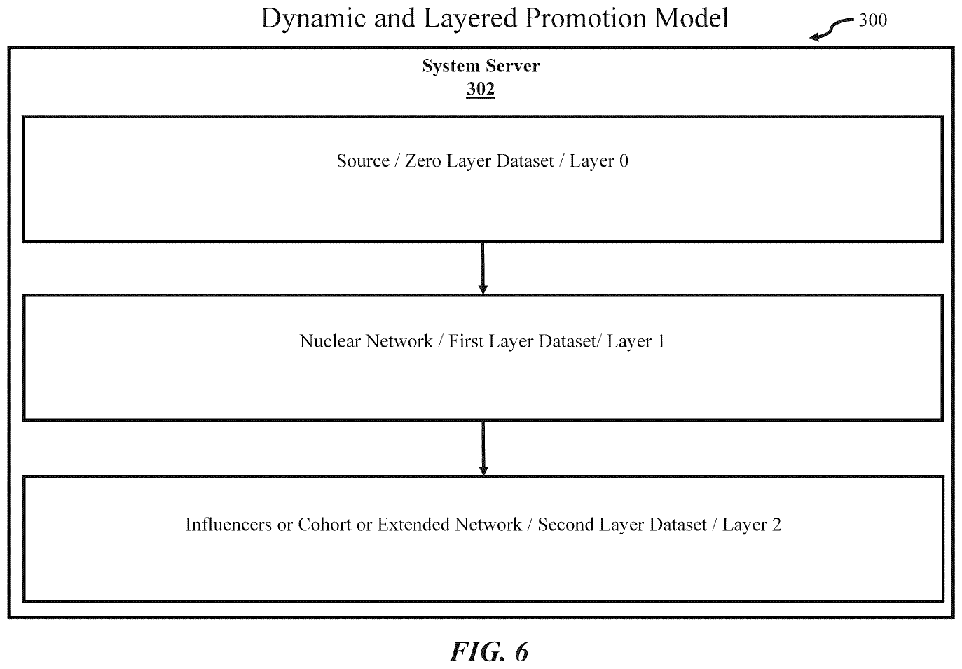

In particular, and according to various embodiments of the present disclosure, the at least one system server 302 may constitute a layered promotion model system involving a layered promotion model, for example, as illustrated schematically in FIG. 6. The plurality of remote platforms 304 may include a seller device 334, a buyer device 336, a peer device 338, and at least one third party server 340, for example. One of ordinary skill in the art may also select suitable types of hardware for each of the seller device 334, the buyer device 336, the peer device 338, and the at least one third party server 340, as well as additional computer devices (not shown), within the scope of the present disclosure.

As shown in FIGS. 4A and 4B, the seller device 334 may have a seller device human interface 342, a seller device memory 344, a seller device processor 346, and a seller device display 348. The seller device human interface 342 may be configured for use by a seller and for providing a zero party dataset and a nomination dataset. The zero party dataset may include a seller-determined criteria dataset that represents a value system of the seller. The nomination dataset represents a plurality of peers proposed by a seller as forming a nuclear network (shown in FIG. 6) of the seller. The nomination dataset may further include peer details such as descriptions and biographies associated with each of the plurality of peers. One of ordinary skill in the art may also select other suitable data or information to include each of the zero party dataset and the nomination dataset, as desired.

The buyer device 336 has a buyer device human interface 350, a buyer device memory 352, a buyer device processor 354, and a buyer device display 356. The buyer device human interface 350 is configured for use by a buyer and for placing an authorized programmatic product order, as is described further herein.

With continued reference to FIGS. 4A and 4B, the peer device 338 has a peer device human interface 358, a peer device memory 360, a peer device processor 362, and a peer device display 364. The peer device human interface 358 is configured for use by at least one nominated peer and for accepting a nomination request to be included in the nomination dataset, as also described further herein.

The at least one third party server 340 may have a third party server human interface 366, a third party server memory 368, a third party server processor 370, and a third party server display 372. The at least one third party server 340 has at least one third party dataset. The at least one third party server human interface 366 is configured for use by a third party, such as a least one of a social media platform and an influencer, as is described further herein.

As shown in FIGS. 4A and 4B, the at least one system server 302 further may have a system server human interface 373, a system server memory 374, a system server processor 376, and a system server display 377. The at least one system server 302 is in communication with the seller device 334, the buyer device 336, the peer device 338, and at least one third party server 340 through the network 301, as described hereinabove.

With renewed reference to FIGS. 4A and 4B, and as described hereinabove, the system server memory 374 stores the plurality of modules including the machine-readable instructions 305, which may be provided as tangible, non-transitory processor executable instructions, as a non-limiting example. The instructions are configured to execute the method 400 of the present disclosure, by the system server processor 376 or the other processors of the system 300 as detailed herein, and as described hereinbelow and shown in FIGS. 5A to 5D.

Referring now to FIGS. 5A to 5D, the method 400 of the present disclosure may further include a first step 402 of providing the system 300 as described hereinabove. In operation, the method 400 also includes a second step 404 of receiving, by the zero layer data gathering module 308 of the at least one system server 302 from the seller device 334, the zero party dataset and the nomination dataset. In a third step 406, the method then includes creating, by the zero layer creation module 310 of the at least one system server 302, a zero layer dataset based on the zero party dataset. In particular, the zero layer dataset represents an identity archetype of the seller.

Next, the method 400 includes a fourth step 408 of communicating, by the first layer nominating module 312 of the at least one system server 302 to the peer device 338, the nomination request. The nomination request is used for at least one nominated peer of the plurality of peers of the seller. The nomination request may include a communication to the at least one nominated peer asking for an acceptance of the nomination request. The acceptance of the nomination request may then be included in a first layer dataset, which represents the nuclear network of the seller.

As shown in FIG. 5A, the method 400 of the present disclosure may then include a fifth step 410 of receiving, by the first layer data gathering module 314 of the at least one system server 302 from the peer device 338, the acceptance of the nomination request. As mentioned above, the acceptance of the nomination request is provided by the at least one nominated peer of the plurality of peers, which advantageously allows the peers to control whether or not they are to be included in the nuclear network of the seller. The at least one nominated peer then becomes and is considered an at least one accepted peer under the system 300 upon receipt of the acceptance.

Subsequently, the method 400 as shown in FIG. 5B further includes a sixth step 412 of creating, by the first layer creation module 316 of the at least one system server 302, the first layer dataset. The first layer dataset includes an identification of the at least one accepted peer.

In a seventh step 414, as shown in FIG. 5C, the method 400 may further include analyzing, by the zero layer data analysis module 318 of the at least one system server 302, the zero layer dataset. The analysis of the zero layer dataset results in provision of an analyzed zero layer dataset. Similarly, in an eighth step 416, the method 400 may further include analyzing, by the first layer data analysis module 320 of the at least one system server 302, the first layer dataset. The analysis of the first layer dataset results in provision of an analyzed first layer dataset.

Following the analysis, in a ninth step 418 the method 400 may further include a generating, by the criteria derivation module 322 of the at least one system server 302, an anonymized search criteria dataset and a value list dataset of the seller from the analyzed zero layer dataset and the analyzed first layer dataset. Advantageously, this permits for the at least one accepted peer of the plurality of peers in the first layer dataset that meet a predetermined alignment threshold for the seller to be selected on a basis of the anonymized search criteria dataset and the value list dataset. As a non-limiting example, the predetermined alignment threshold may be a percentage alignment preselected by the seller. In one example, the predetermined alignment threshold may be at least eighty percent (e.g., 80%). One of ordinary skill in the art may also select other suitable percentages for the predetermined alignment threshold, as desired.

Referring now to FIG. 5D, the method 400 may further include as a tenth step 420 then permits for a creating, by the authorized programmatic product creation module 324 of the at least one system server 302 an authorized programmatic product. The authorized programmatic product is created from the anonymized search criteria dataset and the value list dataset. The authorized programmatic product importantly represents a packaged audience reach that is enriched through the selection of the at least one accepted peer of the plurality of peers that meets the predetermined alignment threshold for the buyer, for example, as set forth hereinabove.

The method 400 in an eleventh step 422 may include a permitting, by the communication agreement and message forms module 326 of the at least one system server 302, the seller to at least one of authorize, amend, and add terms of messages and forms of communication to be specified in the authorized programmatic product. Importantly, this allows for the seller to maintain agency over their right of publicity, as well as control over specific networks of contacts affiliated with the seller.

The method 400 may then further include a twelfth step 424, as shown in FIG. 5D, which involves receiving, by the order placement module 328 of the at least one system server 302 from the buyer device 336, the authorized programmatic product order. Then, in a thirteenth step 426, the method 400 may further include a transmitting, by the order placement module 328 of the at least one system server 302, to the buyer device 336 the authorized programmatic product order. It should be appreciated that the buyer is thereby provided with the authorized programmatic product, which represents the nuclear network of the seller. As described herein, the authorized programmatic product may also be limited according to the terms of the messages and the forms of communication specified by the seller.

In some cases, the plurality of modules of the at least one system server 302 may further include a second layer data gathering module 378, a second layer creation module 380, and a second layer dataset analysis module 382. One of ordinary skill in the art may also select other suitable modules for use with the at least one system server 302 of the present disclosure, as desired.

In such cases where the plurality of modules of the at least one system server 302 further includes the second layer data gathering module 378, the second layer creation module 380, and the second layer dataset analysis module 382, for example, as shown in FIG. 5C, the method 400 may also include an additional step 428 of receiving, by the second layer data gathering module 378 of the at least one system server 302 from the at least one third party server 340, at least one third party dataset. The method 400 may also include a next step 430 of creating, by the second layer creation module 380 of the at least one system server 302, a second layer dataset. The second layer dataset may be based on the at least one third party dataset. Importantly, the second layer dataset may represent at least one cohort of an extended network of the seller. The at least one cohort is an individual aligned with the seller but not one of the plurality of peers of the seller, as described herein.

In some cases, the individual or the cohort aligned with the seller, but which is not one of the plurality of peers of the seller, may be an influencer. Likewise, the at least one third party server 340 may be a social media platform server. It should be appreciated that the social media platform server may be access through an API intersection that is accepted by the social media platform server that uniquely allows for the analysis of the second layer dataset, which may then be used together with the analyzed zero layer dataset and the analyzed first layer dataset, in the step 418 of generating the anonymized search criteria dataset and the value list dataset of the seller.

As shown in FIG. 5C, the method 400 may also include a further step 432 of analyzing, by the second layer dataset analysis module 382 of the at least one system server 302, the second layer dataset. The analysis provides an analyzed second layer dataset. The method 400 may then proceed forward with a combination of the analyzed zero layer dataset, the analyzed first layer dataset, and the analyzed second layer dataset, resulting in the step 420 of creating the authorized programmatic product as discussed further hereinabove.

In some cases, the step 418 of selecting, on the basis of the anonymized search criteria dataset and the value list dataset, the at least one accepted peer of the plurality of peers in the first layer dataset that meet the predetermined alignment threshold for the value list dataset of the seller may further include a selecting on the basis of the anonymized search criteria dataset and the value list dataset the at least one cohort in the second layer dataset that also meet the predetermined alignment threshold for the seller.

In further cases, the step 404 of receiving the zero party dataset by the at least one system server 302 may also include a step of permitting the seller, by the seller device 334 in communication with the at least one system server 302, to identify a plurality of individuals selected from a group consisting of personal contacts, family, friends, business colleagues, casual acquaintances, known supporters, companions, individuals generally associated with the seller, and combinations thereof, as the plurality of peers proposed by the seller in the nomination dataset of the zero party dataset as forming the nuclear network of the seller.

In such cases, it should also be appreciated that the step 414 of analyzing the zero layer dataset to provide the analyzed zero layer dataset may include a retrieving of the descriptions and the biographies of the plurality of peers from the zero layer dataset. Likewise, the step 414 may include the making of a determination of value system alignment between the seller and the plurality of peers based on the descriptions and the biographies of the plurality of peers and the seller-determined criteria dataset representing the value system of the seller.

In yet additional cases, the plurality of modules of the at least one system server 302 may include the artificial intelligence module 330, and the step 414 of analyzing the zero layer dataset and the determination of the value system alignment may be completed with the artificial intelligence module 330. As non-limiting examples, the artificial intelligence module 330 may include at least one artificial intelligence process, a cyclical supervised machine learning process, a cyclical unsupervised machine learning process, and a Saaty Analytic Hierarchy process (AHP). One of skill in the art may also select other suitable artificial intelligence or machine learning processes for the artificial intelligence module 330 within the scope of the present disclosure.

In even more cases, it should be appreciated that the in the eleventh step 422 of the method 400, the communication agreement and message forms module 326 may also be configured to permit the seller to selectively authorize each of i) a relay of datasets and types of communications through the system, ii) a reach of the first layer dataset and the second layer dataset, and iii) a budget for the creating of the authorized programmatic product. This example is consistent with the superior level of control provided to the seller over their own right of publicity under the system 300 and the method 400 as described herein.

Although the present example is described primarily with respect to the system 300 and method 400, it should be appreciated that, being computer-implemented in scope, the system and method both also have a non-transient computer-readable storage medium in the form of the at least one memory 374 of the system server 302, comprising the instructions being executable by the one or more processors 376 to perform the method 400 as described herein.

### Example 3

Exemplary embodiments of the present technology are provided with particular reference to the FIGS. 6-8 enclosed herewith, together with the following remarks.

Introduction:

The “authorized programmatic” system and method aims to address the deficiencies associated with traditional methods of promotion, which have relied on direct engagement or influencer-based models emulating the likeness of targeted talent. While these approaches can be effective, they lack the scalability and nuanced targeting capabilities to fully capitalize on the true network effects surrounding a talent.

The authorized programmatic system and method allows for a more dynamic and layered promotion strategy. Brands can engage not just with the Source (Layer 0/Source) but also with a Nuclear Network (Layer 1) of individuals nominated by the talent, as well as a wider or extended network (Layer 2) of individuals and influencers identified through influencer management platforms, for example, as shown in FIG. 6.

Advantageously, the system and method of the present disclosure combines first-party information gathered during onboarding from Layer 0 and Layer 1 to form a set of search criteria. Anonymized search criteria and values are then used to retrieve the most aligned individuals from Layer 2. This creates a rich pool of candidates for relaying intended messages and deliverables.

In other words, the authorized programmatic system and method represents a paradigm shift in how talents and brands can harness the power of layered networks to magnify their reach and engagement. The system and method of the present disclosure allows for the relay of communication to a combined reach of Level-0, Level-1, and Level-2 audiences. In turn, this provides for a particularly versatile and efficient approach to modern brand promotion.

Description:

1) Data Gathering from Layer-0

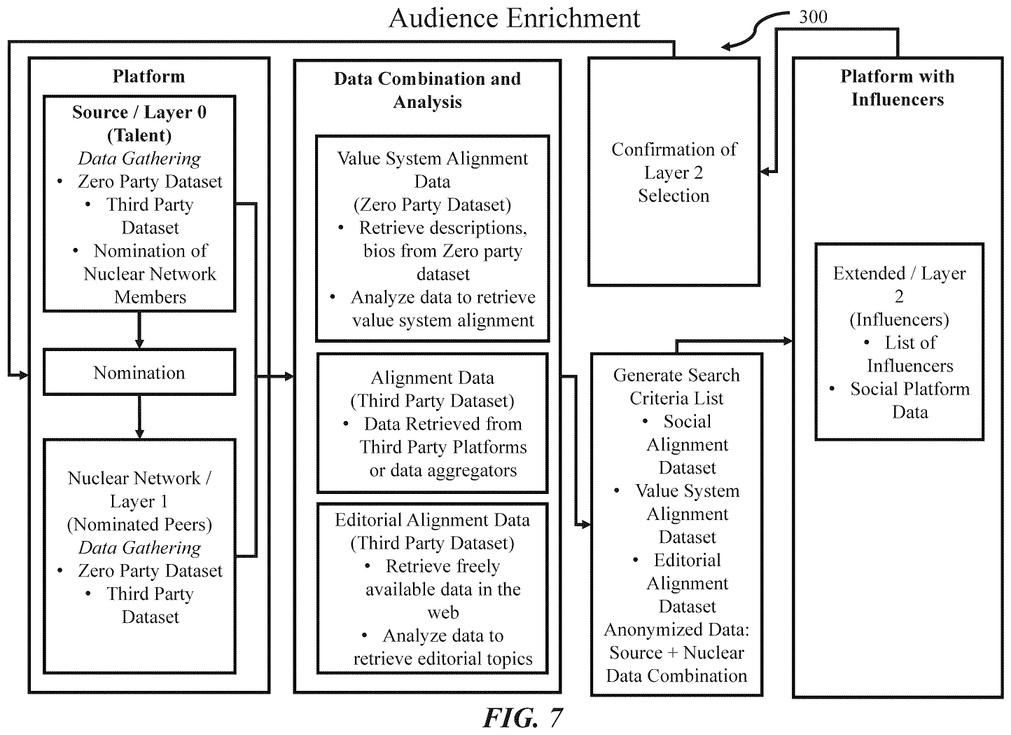

As shown in FIG. 7, the system and method enable talents, referred to as Layer-0, to submit their data. This data is essential for the system to perform its core functionalities, such as creating the Nuclear Network (Layer-1).

2) Nomination of Layer-1 by Layer-0

With further reference to FIG. 7, the talents in Layer-0 have the ability to nominate individuals to be part of Layer-1. The system and method enable the nomination process, including the criteria used for nomination.

3) Data Gathering from Layer-1

Once individuals accept their nomination to be part of Layer-1, the system and method gathers essential data from these nominated individuals, as depicted in FIG. 7. This data is used for various downstream activities including, but not limited to, generating search criteria for Layer-2 selection.

4) Data Analysis and Criteria Derivation

The system and method are also designed to analyze the data from both Layer-0 and Layer-1. Based on this analysis, the system and method generate anonymized search criteria and a value list that serves as the basis for the selection of aligned Layer-1 members.

5) Authorized Programmatic Product Creation

Based on the data and criteria derived, the system and method as shown in FIG. 7 creates the authorized programmatic product. The product can be described as a packaged audience reach that is enriched through the selected members of Layer-1 and Layer-2. This product is available for purchase within the system.

6) Communication Agreement and Message Forms

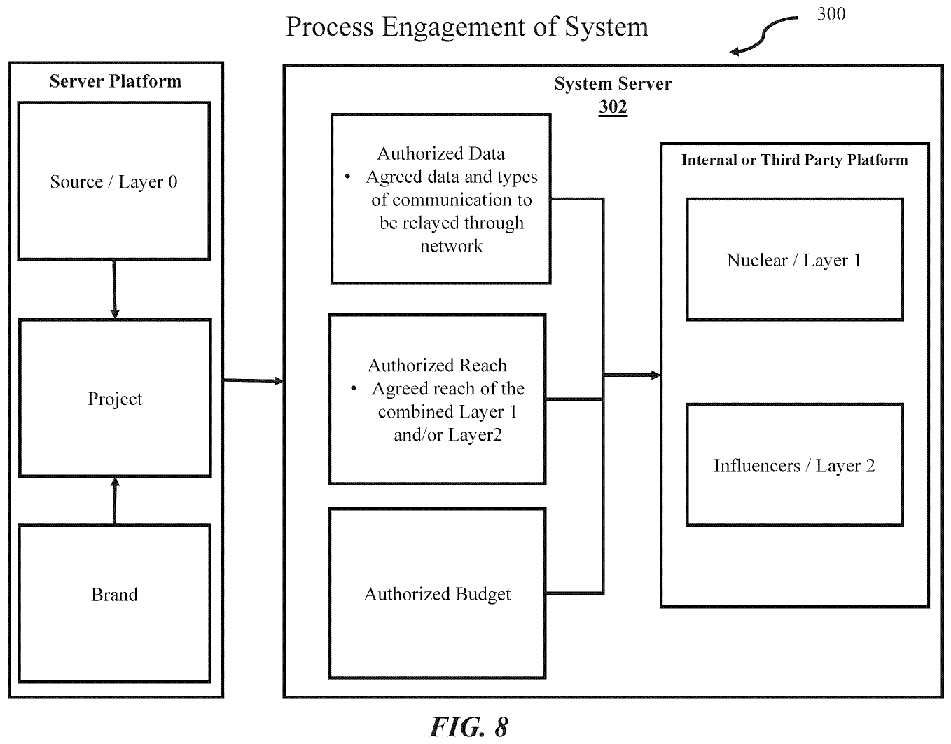

Referring to FIGS. 7 and 8, the system and method allows for the terms of the messages and the forms of communication to be specified in the authorized programmatic product. These terms can be amended or added after the initial purchase. The system and method also allow for the talent to control process engagement and to authorize data and types of communication to be related through the system, as well as the agreed reach of the combined layers, and also an authorized budget for the creation of the authorized programmatic product, as shown in FIG. 8.

7) Order Placement

Returning to FIG. 7, upon agreement on the terms and conditions, an order for the authorized programmatic product can be placed within the system by using the method. The system and method are designed to facilitate this transaction.

8) Distributed Platform Functionality

While the system can exist as a standalone platform, its functionality may also be distributed across multiple platforms, potentially integrating with third-party service or information platforms.

Example embodiments are provided so that this disclosure will be thorough and fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, components and methods may be made within the scope of the present technology, with substantially similar results.

What is claimed is:

1. A method for creating a matching score between a seller and a buyer, the method comprising steps of:
providing a matching system having
a seller device having a seller device human interface, a seller device memory, a seller device processor, and a seller device display, the seller device human interface configured for inputting a seller zero party dataset, the seller zero party dataset including at least one answer by the seller to at least one seller questionnaire, the seller device memory having machine-readable instructions stored on the seller device memory, and the seller device processor in communication with the seller device human interface and the seller device memory,
a buyer device having a buyer device human interface, a buyer device memory, a buyer device processor, and a buyer device display, the buyer device human interface configured for inputting a buyer zero party dataset, the buyer zero party dataset including at least one answer by the buyer to at least one buyer questionnaire, the buyer device memory having machine-readable instructions stored on the buyer device memory, and the buyer device processor in communication with the buyer device human interface and the buyer device memory, and
at least one system server having a system server memory and a system server processor, the at least one system server being accessible by an administrator, the at least one system server in communication with the seller device, the buyer device, and at least one third party server through a wide area network, the at least one third party server having at least one third party dataset, the system server memory storing a buyer needs dataset for the buyer and a plurality of modules including tangible, non-transitory processor executable instructions, the plurality of modules including a social matching score module, a textual matching score module, a presets matching score module, a merging module, and an artificial intelligence module;
receiving, by the at least one system server from the seller device, the seller zero party dataset;
receiving, by the at least one system server from the buyer device, the buyer zero party dataset;
obtaining, by the at least one system server from the at least one third party server, the at least one third party dataset;
calculating, by the social matching score module of the at least one system server, a social matching score from the at least one third party dataset and the buyer needs dataset, the social matching score associated with both the seller and the buyer;
determining, by the textual matching score module of the at least one system server, a textual matching score from the seller zero party dataset and the buyer zero party dataset;
processing, by the presets matching score module of the at least one system server, the at least one answer by the seller to the at least one seller questionnaire and the at least one answer by the buyer to the at least one buyer questionnaire with the artificial intelligence module to provide a presets matching score;
merging, by the merging module of the at least one system server, the social matching score, the textual matching score, and the presets matching score with a merging algorithm to provide the matching score between the seller and the buyer, whereby the matching score is an indicator of a degree of alignment of the buyer and the seller; and
transmitting the matching score from the at least one system server to at least one of the seller device and the buyer device.

2. The method of claim 1, wherein at least one of seller zero party dataset and buyer zero party data includes at least one of personal, demographic, behavioral, financial, geographic, tracking, educational, public life, and professional information, information relating to religious and philosophical beliefs, political affiliations, physical characteristics, online activity and social networking, opinions, interests, preferences, affinities, affiliations, needs, likes and dislikes, passions, and personal identifier information.

3. The method of claim 1, wherein third party dataset includes at least one dataset received from at least one of an outsourced website, an external database, and a SaaS platform.

4. The method of claim 1, wherein the matching score is a numerical value between 0 and 100, and wherein 0 indicates no match and 100 indicates a perfect match.

5. The method of claim 1, wherein the social matching score includes a social reach value, and the social reach value is an indication of fame.

6. The method of claim 1, wherein the social matching score is calculated using seller social information including at least one of a number of followers, a trending score, and a daily engagement rate.

7. The method of claim 1, wherein the social matching score is calculated using the at least one third party dataset, the buyer needs dataset, and at least one of the seller zero party dataset and the buyer zero party dataset.

8. The method of claim 1, wherein the method further includes a step of analyzing, by the textual matching score module, at least one seller textual description and at least one buyer textual description with the artificial intelligence module.

9. The method of claim 1, wherein the at least one third party server provides a seller third party dataset and a buyer third party dataset, and the textual matching score is calculated using the seller zero party dataset, the buyer zero party dataset, the seller third party dataset, and the buyer third party dataset.

10. The method of claim 1, wherein at least one of an administrator and the artificial intelligence module provides at least one of i) at least one question and ii) at least one answer choice for at least one of the at least one seller questionnaire and the at least one buyer questionnaire.

11. The method of claim 10, wherein the at least one question may be a multiple choice question or a textual prompt.

12. The method of claim 1, wherein at least one of the administrator and the artificial intelligence module provides at least one seller question that is included in the at least one seller questionnaire, and at least one of the administrator and the artificial intelligence module provides at least one predetermined seller answer to the at least one seller question, and at least one of the administrator and the artificial intelligence module provides at least one buyer question that is included in the at least one buyer questionnaire, and the at least one of the administrator and the artificial intelligence module provides at least one predetermined buyer answer to the at least one buyer question, the at least one buyer question corresponding with the at least one seller question, and at least one of the administrator and the artificial intelligence module provides at least one predetermined seller-buyer answer combination having a predetermined score associated with the predetermined seller-buyer answer combination, and using the artificial intelligence module, the step of processing the at least one answer by the seller and the at least one answer by the buyer further includes calculating the presets matching score for an actual seller-buyer answer combination by assigning the predetermined score associated with the predetermined seller-buyer answer combination that is same as the actual seller-buyer answer combination.

13. The method of claim 1, wherein the matching score is a weighted average of at least the social matching score, the textual matching score, and the presets matching score.

14. The method of claim 1, wherein at least one of a seller additional dataset and a buyer additional dataset is provided by at least one of an administrator, the artificial intelligence module, at least one third party individual, and at least one third party organization.

15. The method of claim 1, wherein the artificial intelligence module is a curated artificial intelligence process.

16. The method of claim 1, wherein the artificial intelligence module includes at least one of a supervised artificial intelligence process, an unsupervised artificial intelligence process, and a Saaty analytical hierarchy process.

17. The method of claim 1, wherein the matching score is an indicator of the degree of alignment of the buyer and the seller with respect to at least one of a project, field, industry, opportunity, and arrangement.

18. The method of claim 1, wherein the matching score is an indicator of the degree of alignment of the buyer and the seller and the degree of alignment of the buyer and of a nuclear network of the seller.

19. A system for creating a matching score between a seller and a buyer, comprising:
a seller device having a seller device human interface, a seller device memory, a seller device processor, and a seller device display, the seller device human interface configured for inputting a seller zero party dataset, the seller zero party dataset including at least one answer by the seller to at least one seller questionnaire, the seller device memory having machine-readable instructions stored on the seller device memory, and the seller device processor in communication with the seller device human interface and the seller device memory,
a buyer device having a buyer device human interface, a buyer device memory, a buyer device processor, and a buyer device display, the buyer device human interface configured for inputting a buyer zero party dataset, the buyer zero party dataset including at least one answer by the buyer to at least one buyer questionnaire, the buyer device memory having machine-readable instructions stored on the buyer device memory, and the buyer device processor in communication with the buyer device human interface and the buyer device memory, and
at least one system server having a system server memory and a system server processor, the at least one system server being accessible by an administrator, the at least one system server in communication with the seller device, the buyer device, and at least one third party server through a wide area network, the at least one third party server having at least one third party dataset, the system server memory storing a buyer needs dataset for the buyer and a plurality of modules including tangible, non-transitory processor executable instructions, the plurality of modules including a social matching score module, a textual matching score module, a presets matching score module, a merging module, and an artificial intelligence module;
wherein the system is configured by machine-readable instructions executed by at least one of the seller device processor, the buyer device processor, and the system server processor to
receive, by the at least one system server from the seller device, the seller zero party dataset;
receive, by the at least one system server from the buyer device, the buyer zero party dataset;
obtain, by the at least one system server from the at least one third party server, the at least one third party dataset;
calculate, by the social matching score module of the at least one system server, a social matching score from the at least one third party dataset and the buyer needs dataset, the social matching score associated with both the seller and the buyer;
determine, by the textual matching score module of the at least one system server, a textual matching score from the seller zero party dataset and the buyer zero party dataset;
process, by the presets matching score module of the at least one system server, the at least one answer by the seller to the at least one seller questionnaire and the at least one answer by the buyer to the at least one buyer questionnaire with the artificial intelligence module to provide a presets matching score;
merge, by the merging module of the at least one system server, the social matching score, the textual matching score, and the presets matching score with a merging algorithm to provide the matching score between the seller and the buyer, whereby the matching score is an indicator of a degree of alignment of the buyer and the seller; and
transmit the matching score from the at least one system server to at least one of the seller device and the buyer device.

20. A non-transient computer-readable storage medium comprising instructions being executable by one or more processors to perform a method, the method comprising:
providing a matching system for creating a matching score between a seller and a buyer having
a seller device having a seller device human interface, a seller device memory, a seller device processor, and a seller device display, the seller device human interface configured for inputting a seller zero party dataset, the seller zero party dataset including at least one answer by the seller to at least one seller questionnaire, the seller device memory having machine-readable instructions stored on the seller device memory, and the seller device processor in communication with the seller device human interface and the seller device memory,
a buyer device having a buyer device human interface, a buyer device memory, a buyer device processor, and a buyer device display, the buyer device human interface configured for inputting a buyer zero party dataset, the buyer zero party dataset including at least one answer by the buyer to at least one buyer questionnaire, the buyer device memory having machine-readable instructions stored on the buyer device memory, and the buyer device processor in communication with the buyer device human interface and the buyer device memory, and
at least one system server having a system server memory and a system server processor, the at least one system server being accessible by an administrator, the at least one system server in communication with the seller device, the buyer device, and at least one third party server through a wide area network, the at least one third party server having at least one third party dataset, the system server memory storing a buyer needs dataset for the buyer and a plurality of modules including tangible, non-transitory processor executable instructions, the plurality of modules including a social matching score module, a textual matching score module, a presets matching score module, a merging module, and an artificial intelligence module;
receiving, by the at least one system server from the seller device, the seller zero party dataset;
receiving, by the at least one system server from the buyer device, the buyer zero party dataset;
obtaining, by the at least one system server from the at least one third party server, the at least one third party dataset;
calculating, by the social matching score module of the at least one system server, a social matching score from the at least one third party dataset and the buyer needs dataset, the social matching score associated with both the seller and the buyer;
determining, by the textual matching score module of the at least one system server, a textual matching score from the seller zero party dataset and the buyer zero party dataset;
processing, by the presets matching score module of the at least one system server, the at least one answer by the seller to the at least one seller questionnaire and the at least one answer by the buyer to the at least one buyer questionnaire with the artificial intelligence module to provide a presets matching score;
merging, by the merging module of the at least one system server, the social matching score, the textual matching score, and the presets matching score with a merging algorithm to provide the matching score between the seller and the buyer, whereby the matching score is an indicator of a degree of alignment of the buyer and the seller; and
transmitting the matching score from the at least one system server to at least one of the seller device and the buyer device.
